(19) United States
(12) Patent Application Publication
(10) Pub. No.: US 2019/0349562 A1
(43) Pub. Date: Nov. 14, 2019

(54) METHOD FOR PROVIDING INTERFACE FOR ACQUIRING IMAGE OF SUBJECT, AND ELECTRONIC DEVICE

(71) Applicant: SAMSUNG ELECTRONICS CO., LTD., Suwon-si, Gyeonggi-do (KR)

(72) Inventors: Dong Keun OH, Suwon-si, Gyeonggi-do (KR); Gil Yoon KIM, Yongin-si, Gyeonggi-do (KR); Jeong Ki KIM, Suwon-si, Gyeonggi-do (KR); Min Jung KIM, Hwaseong-si, Gyeonggi-do (KR); Jong Hoon WON, Suwon-si, Gyeonggi-do (KR)

(21) Appl. No.: 16/478,525

(22) PCT Filed: Feb. 5, 2018
(86) PCT No.: PCT/KR2018/001485

§ 371 Date: Jul. 17, 2019

(30) Foreign Application Priority Data
Feb. 14, 2017 (KR) 10-2017-0019822

(51) Int. Cl. H04N 13/221; G06T 7/70; G06T 7/20

(52) U.S. Cl. CPC H04N 13/221; G06T 7/70; H04M 1/0202; G06T 2207/30241; G06T 7/20

(57) ABSTRACT

An electronic device includes a sensor that detects movement of the electronic apparatus, a camera photographing an external object to the apparatus, a display outputting an image corresponding to the external object to the apparatus, and a processor being electrically connected to the display. The processor obtains a first image of a part of the external object to the apparatus through the camera, wherein the obtaining of the first image includes identifying a first position of the electronic apparatus with respect to the external object to the apparatus using the sensor, determines a movement path of the electronic apparatus from the first position to a second position capable of obtaining a second image to generate a stereoscopic image of the external object to the apparatus with the first image, and outputs a virtual path corresponding to the movement path through the display.

### TECHNICAL FIELD

Embodiments of the disclosure relate to a technique for providing an interface to obtain an image of an object.

### BACKGROUND ART

With the development of a technique for scanning an object, an electronic apparatus including a part capable of scanning the object, such as a camera and an infrared sensor, has become widespread. The electronic apparatus may form a three-dimensional scan image using the image scanned by the part and output the three-dimensional scan image through a display. In addition, the electronic apparatus may model the object through a three-dimensional print.

The electronic apparatus may be classified as a fixed electronic apparatus and a handheld electronic apparatus depending on a scanning method of the object. The fixed type electronic apparatus may scan the object in a three dimension by rotating the object placed on a turntable and by scanning the rotating object with the part. In the case of a handheld electronic apparatus, a user may directly rotate the handheld electronic apparatus to scan the object placed on a plane in a three dimension.

### DISCLOSURE

### Technical Problem

In the handheld electronic device, the quality of the three-dimensional scan image may be low because the user directly rotates the handheld electronic device around the subject. For example, because the user rotates the handheld electronic device directly around the subject, the path through which the handheld electronic device rotates about the subject may not be constant. When the path through which the handheld electronic device rotates around the subject is not constant, the quality of the three-dimensional scan image may be low because the scanned area is not constant either. Therefore, there is a need to provide the user with a guide for keeping the path of rotation of the electronic device around the subject constant.

In addition, a three-dimensional scanning algorithm of the handheld electronic apparatus may include scanning the object through one pipeline mainly, thereby increasing power consumption of the electronic apparatus unnecessarily. For example, when the path through which the handheld electronic apparatus rotates around the object is constant, there is no need to drive the pipeline to correct the three-dimensional scan image. However, in the three-dimensional scan algorithm of a conventional handheld electronic apparatus, although the path through which the handheld electronic apparatus rotates around the object is constant, the pipeline may be driven for correcting the three-dimensional scan image, thereby increasing the power consumption of the electronic apparatus.

Embodiments disclosed in the disclosure are intended to provide an electronic apparatus for solving the above-mentioned problems and the problems raised in the disclosure.

### Technical Solution

An electronic apparatus according to an embodiment of the disclosure may include a sensor that detects movement of the electronic apparatus, a camera that photographs an external object to the apparatus, a display that outputs an image corresponding to the external object to the apparatus, and a processor that is electrically connected to the display. The processor may be configured to obtain a first image of a part of the external object to the apparatus through the camera, wherein the obtaining of the first image may include identifying a first position of the electronic apparatus with respect to the external object to the apparatus using the sensor, determine a movement path of the electronic apparatus from the first position to a second position capable of obtaining a second image to generate a stereoscopic image of the external object to the apparatus with the first image, and output a virtual path corresponding to the movement path through the display.

Further, a method of photographing an external object to an electronic apparatus according to an embodiment of the disclosure may include identifying a first position of the electronic apparatus through a sensor, obtaining a first image with respect to a part of the external object to the apparatus through a camera, determining a movement path of the electronic apparatus from the first position to a second position capable of obtaining a second image to generate a stereoscopic image of the external object to the apparatus with the first image, and outputting a virtual path corresponding to the movement path through a display.

In addition, a storage medium for storing computer-readable instructions according to an embodiment of the disclosure that, when executed by an electronic device, cause the electronic device to identify a first position of the electronic device through a sensor, to obtain a first image with respect to a part of an external object to the apparatus through a camera, to determine a movement path of the electronic apparatus from the first position to a second position capable of obtaining a second image to generate a stereoscopic image of the external object to the apparatus with the first image, and to output a virtual path corresponding to the movement path through a display.

### Advantageous Effects

According to embodiments of the disclosure, a path for uniformly scanning an object may be provided to a user, and therefore a three-dimensional scan image having high quality may be obtained.

In addition, according to embodiments of the disclosure, an additional pipeline may be driven only when an electronic apparatus deviates in a threshold region, and therefore power consumption of the electronic apparatus may be decreased.

In addition, various effects may be provided that are directly or indirectly grasped through the disclosure.

### DESCRIPTION OF DRAWINGS

FIG. 1 illustrates a block diagram of an electronic device for scanning an object in a three dimension according to an embodiment;

FIG. 2 illustrates an electronic device for determining a horizontal guide and a virtual path output adjacent to the horizontal guide according to an embodiment;

FIG. 3A illustrates an operational flowchart of an electronic device according to an embodiment;

FIG. 3B illustrates an operational flowchart of an electronic device according to another embodiment;

FIG. 4 illustrates a virtual path changed by a movement path according to an embodiment;

FIG. 5 illustrates a virtual path when a horizontal guide and a movement path are in the same plane according to an embodiment;

FIG. 6 illustrates an electronic device for obtaining relative positional information between an electronic device and an object according to an embodiment;

FIG. 7A illustrates a threshold region set adjacent to a virtual path and a horizontal guide according to an embodiment;

FIG. 7B illustrates a block diagram of program modules according to an embodiment;

FIG. 8 illustrates an electronic device which performs loop closure according to an embodiment;

FIG. 9 illustrates a three-dimensional scan image with distortion and a three-dimensional scan image without distortion according to an embodiment.

FIG. 10 illustrates an electronic device in a network environment system, according to various embodiments;

FIG. 11 illustrates a block diagram of an electronic device, according to various embodiments; and

FIG. 12 illustrates a block diagram of a program module, according to various embodiments.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

An electronic device according to various embodiments of the disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the disclosure may not be limited to the above-described electronic devices and may include other electronic devices and new electronic devices according to the development of technologies.

Hereinafter, electronic devices according to various embodiments will be described with reference to the accompanying drawings. In the disclosure, the term “user” may refer to a person who uses an electronic device or may refer to a device (e.g., an artificial intelligence electronic device) that uses the electronic device.

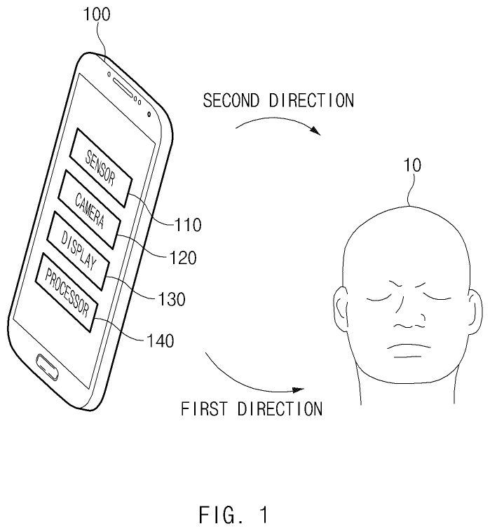

FIG. 1 illustrates a block diagram of an electronic device for scanning an object in a three dimension according to an embodiment.

Referring to FIG. 1, an electronic device 100 may scan an object 10 (or an external object to the electronic device) by moving around the object 10 in a three dimension. The object 10 may be an object having a certain shape such as a human, an animal, a thing, and the like. A three-dimensional scan may photograph the object 10 in not one direction but in several directions. Although FIG. 1 illustrates that the electronic device 100 three-dimensionally scans the object 10 while moving in a first direction or a second direction, the electronic device 100 may three-dimensionally scan the object 10 while moving in directions other than the first direction and the second direction. In the disclosure, the first direction and the second direction may be any direction around the object 10.

Again, referring to FIG. 1, the electronic device 100 (e.g., an electronic device 1001 or 1101) may include a sensor 110 (e.g., a sensor module 1140), a camera 120 (e.g., a camera module 1191), a display 130 (e.g., a display 1060 or 1160), and a processor 140 (e.g., a processor 1020 or 1110).

The sensor 110 (e.g., an inertial measurement unit sensor (IMU) sensor) may detect a slope of the electronic device 100. For example, the sensor 110 may measure angular velocities with regard to roll, pitch, and yaw, respectively, and integrate the respective angular velocities to obtain the slope of the electronic device 100. According to an embodiment, the sensor 110 may obtain relative positional information between the electronic device 100 and the object 10. The sensor 110 may include an IR emitter and an IR sensor for getting depth information of the object.

The camera 120 may obtain an image of the object 10. According to an embodiment, the camera 120 may obtain a specific number or more of images while moving along a path through which the electronic device 100 travels. For example, the camera 120 may obtain images of the object 10 at a plurality of points included in the path through which the electronic device 100 travels, based on user input. In another embodiment, the camera 120 may continuously obtain the images of the object 10 from a time when photographing starts to a time when the photographing ends. The time when the photographing starts and the time when the photographing ends may be different depending on the user input. The camera 120 may include an IR camera to get the image or the depth of the object.

The display 130 may output the image of the object 10. According to an embodiment, the display 130 may continuously output the images of the object 10 while the camera 120 photographs the object 10. In another embodiment, the display 130 may output a three-dimensional scan image (or a stereoscopic image). For example, the processor 140 may combine the images of the object 10 obtained through the camera 120 to generate the three-dimensional scan image. The display 130 may output the three-dimensional scan image.

The processor 140 may determine a path through which the electronic device 100 travels for the three-dimensional scan in response to beginning of the three-dimensional scan. For example, when the electronic device 100 moves, the processor 140 may determine a movement path based on the relative positional information between the electronic device 100 and the object 10 obtained from the sensor 110.

According to an embodiment, the processor 140 may output a horizontal guide which surrounds the object 10 through the display 130. The horizontal guide may be in the form of a closed curve such as an ellipse or a circle, and a center of the object 10 may be located at a center of the horizontal guide.

According to an embodiment, the processor 140 may output a virtual path to be adjacent to the horizontal guide through the display 130. The virtual path is a path which is changed such that the movement path through which the electronic device 100 actually travels is to be adjacent to the horizontal guide (or a path which is obtained by changing coordinate values of the actual movement path with respect to a plane on which the horizontal guide is disposed). When the virtual path is displayed on the display 130, a user may scan the object 10 three-dimensionally while viewing the virtual path. According to an embodiment of the disclosure, because the horizontal guide is a line surrounding the center of the object 10 and the virtual path is output adjacent to the horizontal guide, the object 10 may be photographed based on the virtual path to get a three-dimensional scan image having excellent quality.

In the disclosure, components having the same reference numerals as those of the electronic device 100 shown in FIG. 1 may be applied to the same components as those shown in FIG. 1.

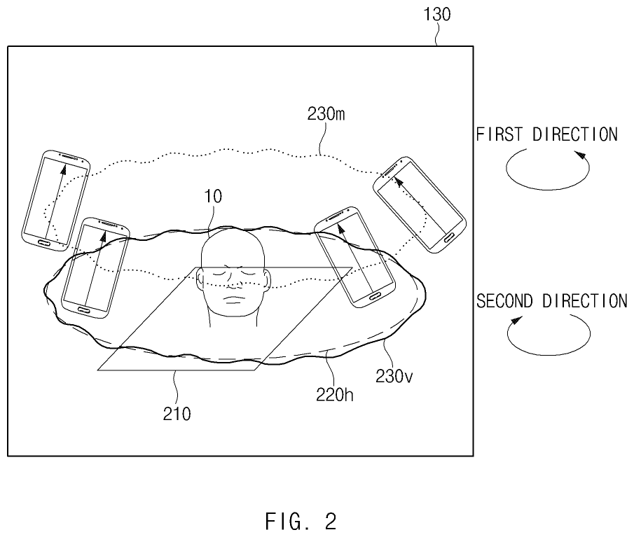

FIG. 2 illustrates an electronic device for determining a horizontal guide and a virtual path output adjacent to the horizontal guide according to an embodiment.

Referring to FIG. 2, the electronic device 100 may determine a ground plane 210 which supports the object 10 when the object 10 is photographed through the camera 120. According to an embodiment, the electronic device 100 may determine the ground plane 210 using a plane estimation algorithm. For example, when a sculpture is placed on a desk, a surface of the desk may be determined as the ground plane 210. When the ground plane 210 is determined, the electronic device 100 may obtain a plane, which is parallel to the ground plane 210 and includes a center of the object 10. In an embodiment, the center of the object 10 may be a centroid of the object 10, and the centroid may be obtained based on a point cloud. When the center and the plane are obtained, the electronic device 100 may output a horizontal guide 220h, which is disposed on the plane and surrounds the object 10, through the display 130.

According to an embodiment, the electronic device 100 may obtain a movement path 230m through which the electronic device 100 moves for photographing the object 10. The movement path 230m may be output through the display 130 or not. When the movement path 230m is obtained, the electronic device 100 may obtain a virtual path 230v by changing coordinate values of the movement path 230m. The obtained virtual path 230v may be output through the display 130. The virtual path 230v may be disposed on the plane which is parallel to the ground plane 210 and includes the center of the object 10. The virtual path 230v may be positioned between the horizontal guide 220h and the object 10 or may be disposed outside the horizontal guide 220h. That is, the virtual path 230v may be closer to the object 10 than the horizontal guide 220h, or may be disposed farther than the horizontal guide 220h.

According to an embodiment, when the virtual path 230v is output near the horizontal guide 220h, the user may scan the object 10 three-dimensionally based on the virtual path 230v. When the object 10 is photographed along the horizontal guide 220h, the three-dimensional scan image having high quality may be obtained. Thus, the electronic device 100 may output the virtual path 230v adjacent to the horizontal guide 220h. In addition, according to an embodiment of the disclosure, the electronic device 100 may output the virtual path 230v to be adjacent to the horizontal guide 220h regardless of a position where the electronic device 100 photographs the object 10, and therefore the three-dimensional scan image having the high quality may be obtained.

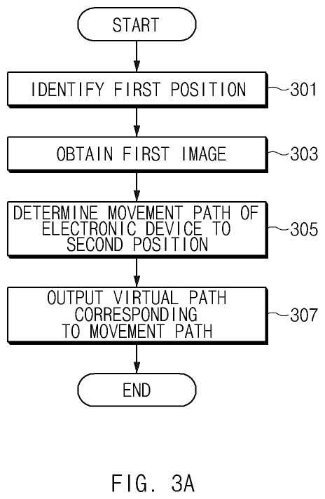

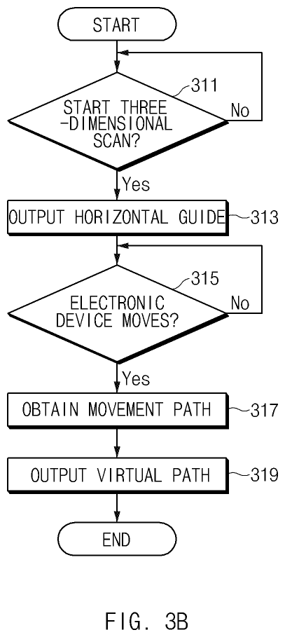

FIG. 3A illustrates an operational flowchart of an electronic device according to an embodiment. FIG. 3B illustrates an operational flowchart of an electronic device according to another embodiment. The operational flowcharts shown in FIGS. 3A and 3B are operational flowcharts of the electronic device shown in FIG. 2.

Referring to FIG. 3A, in operation 301, the electronic device 100 may detect a first position of the electronic device 100 via the sensor 110 (e.g., an IMU sensor). For example, the sensor 110 may detect the first position of the electronic device 100 within a coordinate system (e.g., a spherical coordinate system) generated by the electronic device 100.

In operation 303, the electronic device 100 may obtain a first image of the object 10 (or the external object to the electronic device). The first image may be an image for a part of the object 10. In addition, the first image may be an image of the object 10 which is capable of being photographed through the camera 120 when the electronic device 100 is at the first position.

In operation 305, the electronic device 100 may determine the movement path of the electronic device 100. For example, the electronic device 100 may determine the movement path such that the first position and a second position are included. The second position may be a position of the electronic device 100 capable of obtaining a second image. The second image may be an image which is capable of being combined with the first image to generate a stereoscopic image (or the three-dimensional scan image).

In operation 307, the electronic device 100 may output the virtual path through the display 130. For example, the electronic device 100 may determine the virtual path by changing the coordinate values of the movement path. When the virtual path is determined, the electronic device 100 may output the determined virtual path through the display 130.

Referring to FIG. 3B, in operation 311, the electronic device 100 may determine whether the three-dimensional scan starts. For example, the electronic device 100 may determine whether the three-dimensional scan starts based on whether there is the user input (e.g., touch of the display 130), which executes the three-dimensional scan. When the three-dimensional scan starts, the electronic device 100 may detect the object in operation 313 and may output the horizontal guide, which surrounds the detected object, through the display 130. For example, the electronic device 100 may determine the ground plane of the object and the plane which is parallel to the ground plane and includes the center of the object. When the ground plane and the plane are determined, the electronic device 100 may output the horizontal guide on the plane.

When the horizontal guide is output, the electronic device 100 may determine whether the electronic device 100 moves in operation 315. For example, the electronic device 100 may determine whether the electronic device 100 moves based on the positional information obtained at the sensor 110. For example, when the electronic device 100 moves, the electronic device 100 may obtain the movement path in operation 317. The movement path may be a path along which the electronic device 100 moves around the object.

When the movement path is obtained, in operation 319, the electronic device 100 may change the coordinate values of the movement path to obtain the virtual path and to output the obtained virtual path through the display 130. For example, the electronic device 100 may set the virtual path by changing the coordinate values of the movement path based on the plane on which the horizontal guide is disposed. When the virtual path is set, the electronic device 100 may output the virtual path through the display 130.

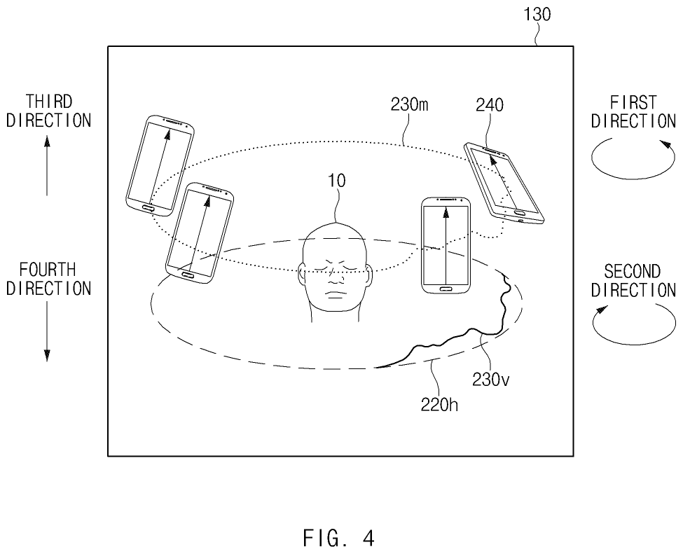

FIG. 4 illustrates a virtual path changed by a movement path according to an embodiment. The embodiment shown in FIG. 4 is an example of operation 319 shown in FIG. 3B. The description in FIG. 4 may have the same reference numerals as the electronic device 100 described in FIGS. 1 and 2 and may be applied in the same manner as described in FIGS. 1 and 2.

Referring to FIG. 4, the electronic device 100 may output the virtual path 230v corresponding to the movement path 230m when the electronic device 100 moves to photograph the object 10. For example, when the user moves the electronic device 100 in the first direction to scan the object 10 three-dimensionally, the virtual path 230v may also be output along the first direction. In addition, when the electronic device 100 is shaken while the user scans the object 10 in the three-dimensional scan, the virtual path 230v may also be changed depending on the shaking of the electronic device 100.

According to an embodiment, the electronic device 100 may detect the slope of the electronic device 100 with respect to the ground plane. The virtual path 230v may be determined based on the slope of the electronic device 100. First, when the camera 120 is disposed at a rear side of the electronic device 100 (or when disposed at an opposite side of the display 130), the display 130 and the camera 120 may be oriented in different directions, respectively. For example, when the electronic device 100 is tilted such that the display 130 is oriented in a third direction, the camera 120 may be oriented in a fourth direction. The virtual path 230v may be changed to the fourth direction because the camera 120 is oriented in the fourth direction.

Conversely, when the camera 120 is disposed at a front side of the electronic device 100 (or when disposed at the same plane as the display 130), the display 130 and the camera 120 may be oriented in the same direction. For example, when the electronic device 100 is tilted such that the display 130 is oriented in the third direction, the camera 120 may also be oriented in the third direction. The virtual path 230v may be changed to the third direction because the camera 120 is oriented in the third direction.

According to an embodiment, the electronic device 100 may output an icon 240 having a slope corresponding to the slope of the electronic device 100 through the display 130. For example, when the display 130 is tilted toward the third direction, the electronic device 100 may output the tilted icon 240 such that the display 130 may be tilted toward the third direction. According to an embodiment of the disclosure, the user may easily recognize the slope of the electronic device 100 by changing the virtual path or outputting the icon based on the slope of the electronic device 100.

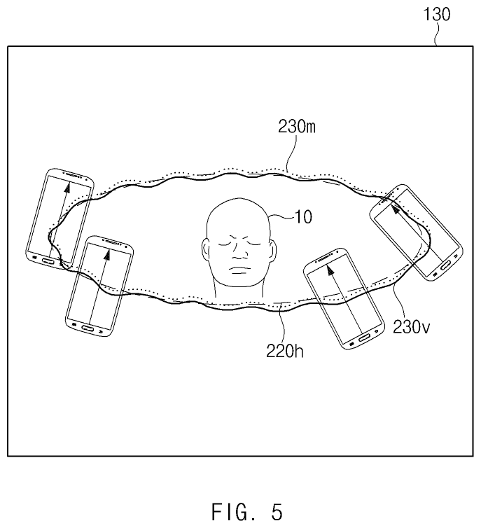

FIG. 5 illustrates a virtual path when a horizontal guide and a movement path are in the same plane according to an embodiment. The embodiment shown in FIG. 5 is an example of operation 319 shown in FIG. 3B.

Referring to FIG. 5, the virtual path 230v may be determined based on relative position information between the electronic device 100 and the object 10. For example, when a distance between the electronic device 100 and the object 10 is close, an area capable of three-dimensionally scanning may be considerably changed although the electronic device 100 moves slightly. Therefore, the virtual path 230v may be considerably changed. Unlike the above example, when a distance between the electronic device 100 and the object 10 is far, difference of the area capable of three-dimensionally scanning may not be large although the electronic device 100 moves. Therefore, variation amount of the virtual path 230v may be small although the electronic device 100 moves.

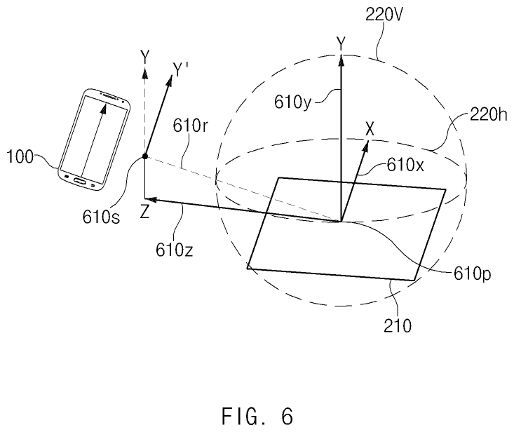

FIG. 6 illustrates an electronic device for obtaining relative positional information between an electronic device and an object according to an embodiment.

Referring to FIG. 6, the electronic device 100 may obtain a first axis 610y (e.g., an Y axis) which is perpendicular to the ground plane 210 supporting the object 10, and a second axis 610z (e.g., a Z axis), which is perpendicular to the ground plane 210 and is disposed on a plane including a position 610s where the three-dimensional scan starts. A third axis 610x (e.g., an X axis) passing through an intersection of the first axis 610y and the second axis 610z and a reference line 610r connecting the electronic device 100 to an intersection point 610p of the first axis 610y, the second axis 610z, and the third axis 610x may be obtained.

According to an embodiment, when a specific radius is designated in a coordinate system defined by the first axis 610y, the second axis 610z, and the third axis 610x, a coordinate system (e.g., a spherical coordinate system) may be generated. In this case, the specific radius may correspond to the reference line 610r. When the spherical coordinate system is generated, the electronic device 100 may obtain relative position information between the electronic device 100 and the object 10. For example, the electronic device 100 may generate the horizontal guide 220h in the spherical coordinate system. When the horizontal guide 220h is generated, the electronic device 100 may have coordinate values obtained by projecting each point, which is on the movement path, onto a spherical surface. The electronic device 100 may convert the obtained coordinate values based on the horizontal guide 220h and may obtain the virtual path based on the converted coordinate values.

According to an embodiment, the electronic device 100 may obtain a relative position based on the coordinate values of the electronic device 100 and coordinate values of object 10 in a coordinate system (e.g. an orthogonal coordinate system) including the first axis 610y, the second axis 610z, and the third axis 610x. For example, the electronic device 100 may set the coordinate values of the object to (0, 0, 0), and may generate the horizontal guide 220h (e.g., coordinate values of the horizontal guide 220h are (x, 0, z)) based on the coordinate values. When the horizontal guide 220h is generated, the electronic device 100 may obtain each coordinate value on the movement path and convert the obtained coordinate values with respect to the horizontal guide 220h. When the coordinate values are converted, the electronic device 100 may obtain the virtual path based on the converted coordinate values.

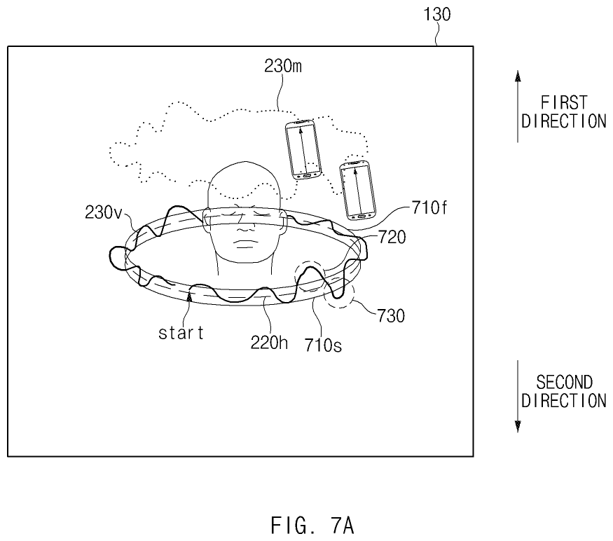

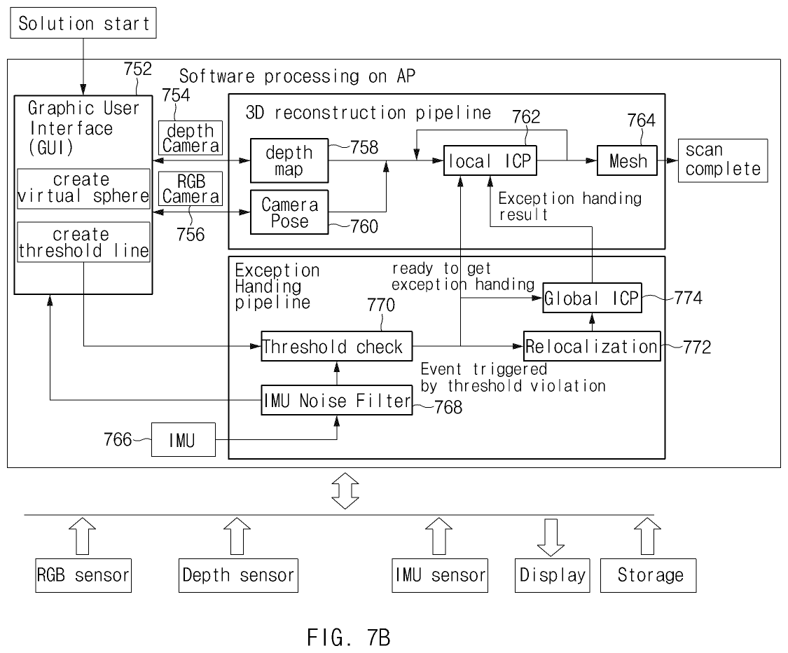

FIG. 7A illustrates a threshold region set adjacent to a virtual path and a horizontal guide according to an embodiment. FIG. 7B illustrates a block diagram of program modules according to an embodiment.

Referring to FIG. 7A, the electronic device 100 may set a threshold region based on the position of the horizontal guide 220h. For example, the electronic device 100 may set a first guide 710f, which is parallel to the horizontal guide 220h and is spaced apart from the horizontal guide 220h by a specific distance, and a second guide 710s, which is disposed on an opposite side of the first guide 710f with respect to the horizontal guide 220h. The threshold region may be any region between the first guide 710f and the second guide 710s.

When the threshold region is set, the electronic device 100 may output the threshold region and the virtual path 230v through the display 130. The virtual path 230v may be disposed within the threshold region or may be disposed outside the threshold region. For example, when the electronic device 100 moves in the first direction, the virtual path 230v may deviate in the first direction with respect to the threshold region within a region 720. Unlike the example described above, when the electronic device 100 moves in the second direction, the virtual path 230v may deviate in the second direction with respect to the threshold region within the region 730.

According to an embodiment of the disclosure, the object 10 may be scanned based on the first guide line 710f and the second guide line 710s, thereby obtaining the three-dimensional scan image having good quality.

Referring to FIG. 7B, a GUI (Graphical User Interface) 752 may generate a coordinate system and a guideline. For example, the GUI 752 may generate the spherical coordinate system and the horizontal guide and threshold region within the spherical coordinate system.

A camera module (e.g., a camera module 1191) may photograph the images of the object. For example, a depth camera module 754 may photograph the three-dimensional image including distance information between the electronic device 100 and the object. Also, the depth camera module 754 may photograph a plurality of three-dimensional images while the electronic device 100 rotates around the object. An RGB camera module 756 may photograph an image including the slope of the electronic device 100 and an angle between the object and the electronic device 100.

A depth map module 758 may obtain a distance between the electronic device 100 and the object based on the three-dimensional image obtained by the depth camera module 754. When there are a plurality of three-dimensional images, the depth map module 758 may obtain the distance between the electronic device 100 and the object for each image. A camera pose module 760 may obtain the slope, angle, and the like of the electronic device 100 based on the image obtained from the RGB camera module 756.

A local ICP module 762 may obtain points constituting the object by merging the distance, slope, angle, and the like obtained from the depth map module 758 and the camera pose module 760.

A mesh module 764 may obtain the three-dimensional scan image by forming a surface on the points obtained in the local ICP.

An IMU sensor 766 (e.g., a sensor module 1140) may measure velocity and slope of the electronic device 100. An IMU noise filter module 768 may extract values within an error range from the velocities and slopes obtained from the IMU sensor 766.

A threshold check module 770 may receive the coordinate system and the threshold region from the GUI 752. In addition, the threshold check module 770 may receive the values within the error range from the IMU noise filter module 768. The threshold check module 770 may determine whether the electronic device 100 is out of the threshold region based on the velocities and slopes of the electronic device 100 within the coordinate system. For example, when the electronic device 100 is within the threshold region, the electronic device 100 may obtain the three-dimensional scan image through the local ICP module 762 and the mesh module 764.

Unlike the above example, when the electronic device 100 is out of the threshold region, the electronic device 100 may obtain the three-dimensional scan image through a relocalization module 772 and a global ICP module 774. The relocalization module 772 may estimate a rate of change before a displacement difference is abruptly changed, for continuity of the positions and angles of the electronic device 100 when the displacement difference of the electronic device 100 changes abruptly. The global ICP module 774 may predict the positions of electronic device 100 based on the estimated change rate. The Local ICP module 762 may obtain points that constitute the object and the mesh module 764 may form a surface over the points obtained in the local ICP to obtain the three-dimensional scan image when the positions of the electronic device 100 are predicted.

According to an embodiment of the disclosure, when the relocalization module 772 and the global ICP module 774 operate, an amount of computation of the electronic device 100 may be increased. Thus, the electronic device 100 may operate the relocalization module 772 and the global ICP module 774 only when the virtual path is outside the threshold region. Thus, the electronic device 100 may reduce the amount of computation and power consumption. That is, the electronic device 100 may operate a separate pipeline including the relocalization module 772 and global ICP module 774 only when the virtual path is outside the threshold region. Thus, the electronic device 100 may reduce the amount of computation and power consumption. In the disclosure, the pipeline may refer to a path for correcting distortion generated in the scanned image.

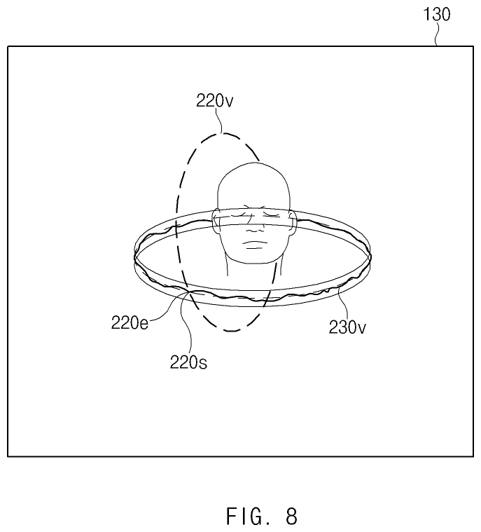

FIG. 8 illustrates an electronic device which performs loop closure according to an embodiment.

Referring to FIG. 8, the electronic device 100 may be set to start the three-dimensional scan at a first point 220s of the virtual path 230v (or the movement path) and to finish the three-dimensional scan at a second point of 220e of the virtual path 230v. In an embodiment of the disclosure, the first point 220s (e.g., the point where the three-dimensional scan starts) and the second point 220e (e.g., the point where the three-dimensional scan ends) may be substantially the same. The electronic device 100 may perform loop closure when the first point 220s and the second point 220e are substantially identical.

In an embodiment, the electronic device 100 may perform loop closure based on a vertical guide 220v. For example, the vertical guide 220v may be disposed on a plane that includes the first point 220s, and thus the user may start the electronic device 100 at a specific point in the vertical guide 220v and may allow the electronic device 100 to arrive at the specific point. The electronic device 100 may perform the loop closure because the point at which the electronic device 100 starts and the point at which the electronic device 100 arrives are the same.

According to an embodiment of the disclosure, when the point where the three-dimensional scan starts and the point where the three-dimensional scan ends are the same, accurate matching between the images may be performed to generate the three-dimensional scan image having the high quality.

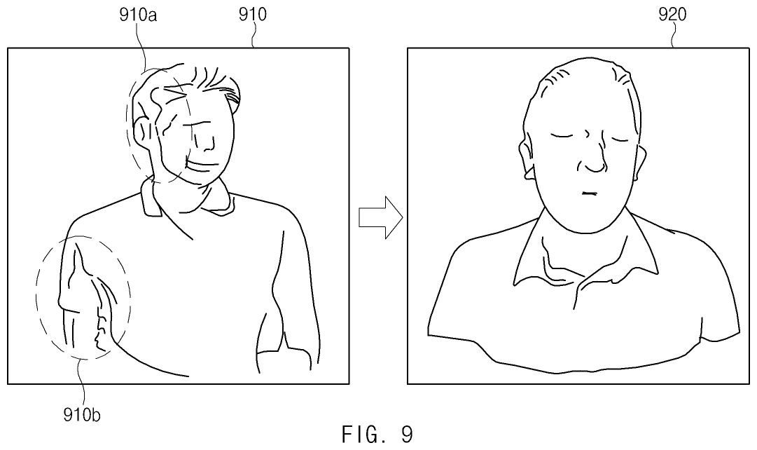

FIG. 9 illustrates a three-dimensional scan image 910 with distortion and a three-dimensional scan image 920 without distortion according to an embodiment.

Referring to FIG. 9, a conventional electronic device may generate a three-dimensional scan image without distortion by correcting the distortion when distortion occurs in the three-dimensional scan image. For example, the conventional electronic device may mainly scan the object 10 through a single pipeline, and correct the distortion in the scanned image to generate the three-dimensional scan image. In this case (when the three-dimensional scan image is generated through one pipeline), the conventional electronic device may perform the correcting of the distortion even though there is no distortion in the scanned image. As a result, the amount of computation is increased and the power consumption may be increased.

However, the electronic device 100 according to an embodiment of the disclosure may perform the correcting of the distortion only when the electronic device 100 is out of the threshold region. Therefore, according to an embodiment of the disclosure, the amount of computation and power consumption of the electronic device may be reduced.

An electronic apparatus according to an embodiment of the disclosure may include a sensor that detects movement of the electronic apparatus, a camera that photographs an external object to the apparatus, a display that outputs an image corresponding to the external object to the apparatus, and a processor that is electrically connected to the display. The processor may be configured to obtain a first image of a part of the external object to the apparatus through the camera, wherein the obtaining of the first image may include identifying a first position of the electronic apparatus with respect to the external object to the apparatus using the sensor, determine a movement path of the electronic apparatus from the first position to a second position capable of obtaining a second image to generate a stereoscopic image of the external object to the apparatus with the first image, and output a virtual path corresponding to the movement path through the display.

The processor according to an embodiment of the disclosure may be configured to determine the virtual path based on the movement path and the movement of the electronic apparatus while the electronic apparatus generates at least a part of the stereoscopic image and output the virtual path with respect to a guide surrounding the external object to the apparatus though the display.

The processor according to an embodiment of the disclosure may be configured to output the stereoscopic image generated based on the first image and the second image through the display.

The processor according to an embodiment of the disclosure may be configured to determine a ground plane supporting the external object to the apparatus and be disposed on a plane parallel to the ground plane for the guide.

The processor according to an embodiment of the disclosure may be configured to detect a slope of the electronic apparatus using the sensor and determine the virtual path based on the slope.

The processor according to an embodiment of the disclosure may be configured to output the movement path through the display

The processor according to an embodiment of the disclosure may be configured to set a threshold region based on a position of the guide and output the threshold region through the display

The processor according to an embodiment of the disclosure may be configured to photograph the external object to the apparatus through a first pipeline based on the virtual path, which is disposed within the threshold region and photograph the external object to the apparatus through the first pipeline and a second pipeline based on the virtual path, which is disposed outside the threshold region.

The processor according to an embodiment of the disclosure may be configured to output a first guide parallel to the guide and spaced apart from the guide by a specific distance and a second guide disposed at an opposite side of the first guide with respect to the guide through the display.

The processor according to an embodiment of the disclosure may be configured to output a vertical guide, which is perpendicular to the guide, is disposed on a plane including a position which starts the photographing, and surrounds the external object to the apparatus, through the display and obtain the first position based on the guide and the vertical guide.

The processor according to an embodiment of the disclosure may be configured to obtain a first axis perpendicular to a ground plane supporting the external object to the apparatus, a second axis which is perpendicular to the first axis and is disposed on a plane including a position where the photographing starts, and a reference line connecting an intersection of the first axis and the second axis to the electronic apparatus and obtain the first position based on the second axis and an angle of the reference line

The processor according to an embodiment of the disclosure may be configured to obtain a third axis perpendicular to the first axis and the second axis and obtain the first position based on coordinate values of the electronic apparatus and coordinate values of the external object to the apparatus in a coordinate system including the first axis, the second axis, and the third axis.

The processor according to an embodiment of the disclosure may be configured to start the electronic apparatus at a first point of the movement path and to finish the photographing when the electronic apparatus arrives at a second point of the movement path and the first point may correspond to the second point

The processor according to an embodiment of the disclosure may be configured to output an icon having a slope corresponding to a slope of the electronic apparatus through the display.

Further, a method of photographing an external object to an electronic apparatus according to an embodiment of the disclosure may include identifying a first position of the electronic apparatus through a sensor, obtaining a first image with respect to a part of the external object to the apparatus through a camera, determining a movement path of the electronic apparatus from the first position to a second position capable of obtaining a second image to generate a stereoscopic image of the external object to the apparatus with the first image, and outputting a virtual path corresponding to the movement path through a display.

The photographing of the external object to the apparatus according to an embodiment of the disclosure may further include determining the virtual path based on the movement path and movement of the electronic apparatus while the electronic apparatus generates at least a part of the stereoscopic image.

The photographing of the external object to the apparatus according to an embodiment of the disclosure may further include outputting the virtual path with respect to a guide surrounding the external object to the apparatus, through the display.

The photographing of the external object to the apparatus according to an embodiment of the disclosure may further include setting a threshold region based on a position of the guide and outputting the threshold region through the display.

The photographing of the external object to the apparatus according to an embodiment of the disclosure may further include photographing the external object to the apparatus through a first pipeline based on the virtual path, which is disposed within the threshold region and photographing the external object to the apparatus through the first pipeline and a second pipeline based on the virtual path, which is outside the threshold region.

In addition, a storage medium for storing computer-readable instructions according to an embodiment of the disclosure that, when executed by an electronic device, cause the electronic device to identify a first position of the electronic device through a sensor, to obtain a first image with respect to a part of an external object to the apparatus through a camera, to determine a movement path of the electronic apparatus from the first position to a second position capable of obtaining a second image to generate a stereoscopic image of the external object to the apparatus with the first image, and to output a virtual path corresponding to the movement path through a display.

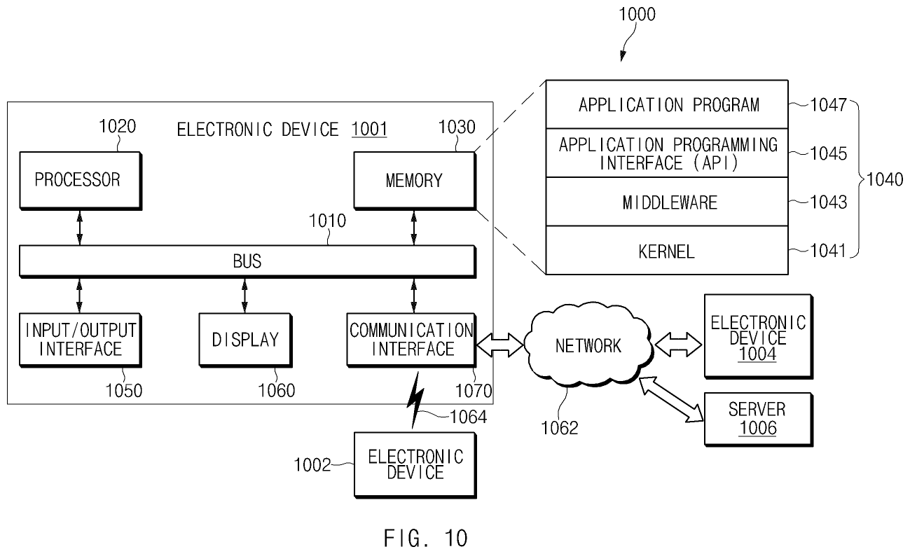

FIG. 10 illustrates an electronic device in a network environment system, according to various embodiments.

Referring to FIG. 10, according to various embodiments, an electronic device 1001, a first electronic device 1002, a second electronic device 1004, or a server 1006 may be connected each other over a network 1062 or a short range communication 1064. The electronic device 1001 may include a bus 1010, a processor 1020, a memory 1030, an input/output interface 1050, a display 1060, and a communication interface 1070. According to an embodiment, the electronic device 1001 may not include at least one of the above-described components or may further include other component(s).

For example, the bus 1010 may interconnect the above-described components 1010 to 1070 and may include a circuit for conveying communications (e.g., a control message and/or data) among the above-described components.

The processor 1020 may include one or more of a central processing unit (CPU), an application processor (AP), or a communication processor (CP). For example, the processor 1020 may perform an arithmetic operation or data processing associated with control and/or communication of at least other components of the electronic device 1001.

The memory 1030 may include a volatile and/or nonvolatile memory. For example, the memory 1030 may store commands or data associated with at least one other component(s) of the electronic device 1001. According to an embodiment, the memory 1030 may store software and/or a program 1040. The program 1040 may include, for example, a kernel 1041, a middleware 1043, an application programming interface (API) 1045, and/or an application program (or “an application”) 1047. At least a part of the kernel 1041, the middleware 1043, or the API 1045 may be referred to as an “operating system (OS)”.

For example, the kernel 1041 may control or manage system resources (e.g., the bus 1010, the processor 1020, the memory 1030, and the like) that are used to execute operations or functions of other programs (e.g., the middleware 1043, the API 1045, and the application program 1047). Furthermore, the kernel 1041 may provide an interface that allows the middleware 1043, the API 1045, or the application program 1047 to access discrete components of the electronic device 1001 so as to control or manage system resources.

The middleware 1043 may perform, for example, a mediation role such that the API 1045 or the application program 1047 communicates with the kernel 1041 to exchange data.

Furthermore, the middleware 1043 may process task requests received from the application program 1047 according to a priority. For example, the middleware 1043 may assign the priority, which makes it possible to use a system resource (e.g., the bus 1010, the processor 1020, the memory 1030, or the like) of the electronic device 1001, to at least one of the application program 1047. For example, the middleware 1043 may process the one or more task requests according to the priority assigned to the at least one, which makes it possible to perform scheduling or load balancing on the one or more task requests.

The API 1045 may be, for example, an interface through which the application program 1047 controls a function provided by the kernel 1041 or the middleware 1043, and may include, for example, at least one interface or function (e.g., an instruction) for a file control, a window control, image processing, a character control, or the like.

The input/output interface 1050 may play a role, for example, of an interface which transmits a command or data input from a user or another external device, to other component(s) of the electronic device 1001. Furthermore, the input/output interface 1050 may output a command or data, received from other component(s) of the electronic device 1001, to a user or another external device.

The display 1060 may include, for example, a liquid crystal display (LCD), a light-emitting diode (LED) display, an organic LED (OLED) display, a microelectromechanical systems (MEMS) display, or an electronic paper display. The display 1060 may display, for example, various contents (e.g., a text, an image, a video, an icon, a symbol, and the like) to a user. The display 1060 may include a touch screen and may receive, for example, a touch, gesture, proximity, or hovering input using an electronic pen or a part of a user's body.

For example, the communication interface 1070 may establish communication between the electronic device 1001 and an external device (e.g., the first electronic device 1002, the second electronic device 1004, or the server 1006). For example, the communication interface 1070 may be connected to the network 1062 over wireless communication or wired communication to communicate with the external device (e.g., the second electronic device 1004 or the server 1006).

The wireless communication may use at least one of, for example, long-term evolution (LTE), LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like, as cellular communication protocol. Furthermore, the wireless communication may include, for example, the short range communication 1064. The short range communication 1064 may include at least one of wireless fidelity (Wi-Fi), Bluetooth, near field communication (NFC), magnetic stripe transmission (MST), a global navigation satellite system (GNSS), or the like.

The MST may generate a pulse in response to transmission data using an electromagnetic signal, and the pulse may generate a magnetic field signal. The electronic device 1001 may transfer the magnetic field signal to point of sale (POS), and the POS may detect the magnetic field signal using a MST reader. The POS may recover the data by converting the detected magnetic field signal to an electrical signal.

The GNSS may include at least one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”) based on an available region, a bandwidth, or the like. Hereinafter, in the disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 1062 may include at least one of telecommunications networks, for example, a computer network (e.g., LAN or WAN), an Internet, or a telephone network.

Each of the first and second electronic devices 1002 and 1004 may be a device of which the type is different from or the same as that of the electronic device 1001. According to an embodiment, the server 1006 may include a group of one or more servers. According to various embodiments, all or a portion of operations that the electronic device 1001 will perform may be executed by another or plural electronic devices (e.g., the first electronic device 1002, the second electronic device 1004 or the server 1006). According to an embodiment, in the case where the electronic device 1001 executes any function or service automatically or in response to a request, the electronic device 1001 may not perform the function or the service internally, but, alternatively additionally, it may request at least a portion of a function associated with the electronic device 1001 from another device (e.g., the electronic device 1002 or 1004 or the server 1006). The other electronic device may execute the requested function or additional function and may transmit the execution result to the electronic device 1001. The electronic device 1001 may provide the requested function or service using the received result or may additionally process the received result to provide the requested function or service. To this end, for example, cloud computing, distributed computing, or client-server computing may be used.

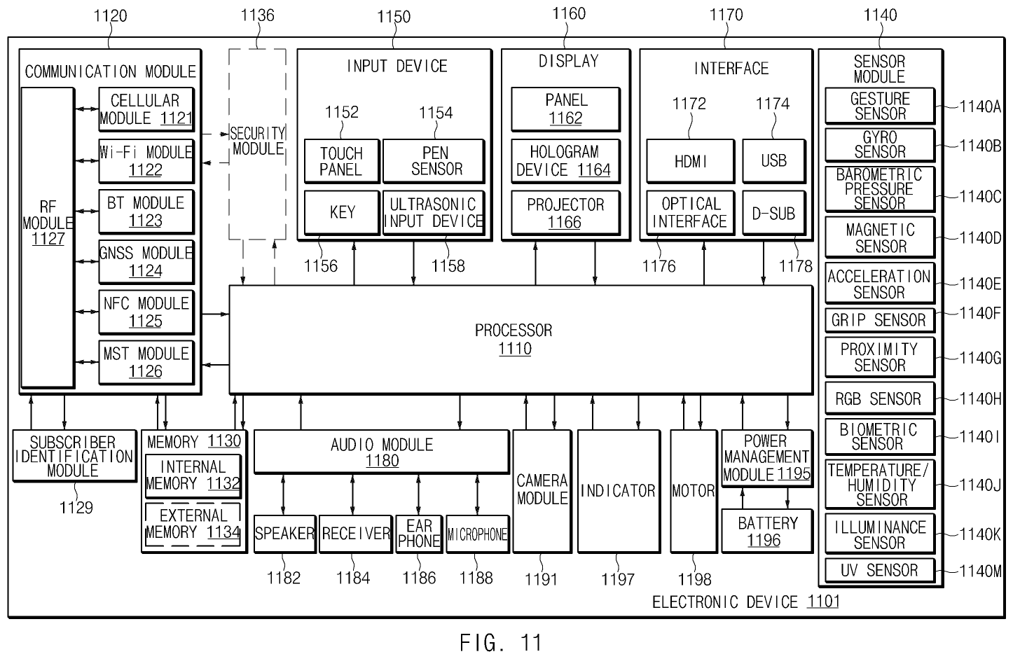

FIG. 11 illustrates a block diagram of an electronic device, according to various embodiments.

Referring to FIG. 11, an electronic device 1101 may include, for example, all or a part of the electronic device 1001 illustrated in FIG. 10. The electronic device 1101 may include one or more processors (e.g., an application processor (AP)) 1110, a communication module 1120, a subscriber identification module 1124, a memory 1130, a sensor module 1140, an input device 1150, a display 1160, an interface 1170, an audio module 1180, a camera module 1191, a power management module 1195, a battery 1196, an indicator 1197, and a motor 1198.

The processor 1110 may drive, for example, an operating system (OS) or an application to control a plurality of hardware or software components connected to the processor 1110 and may process and compute a variety of data. For example, the processor 1110 may be implemented with a System on Chip (SoC). According to an embodiment, the processor 1110 may further include a graphic processing unit (GPU) and/or an image signal processor. The processor 1110 may include at least a part (e.g., a cellular module 1121) of components illustrated in FIG. 11. The processor 1110 may load a command or data, which is received from at least one of other components (e.g., a nonvolatile memory), into a volatile memory and process the loaded command or data. The processor 1110 may store a variety of data in the nonvolatile memory.

The communication module 1120 may be configured the same as or similar to the communication interface 1070 of FIG. 10. The communication module 1120 may include the cellular module 1121, a Wi-Fi module 1122, a Bluetooth (BT) module 1123, a GNSS module 1124 (e.g., a GPS module, a Glonass module, a Beidou module, or a Galileo module), a near field communication (NFC) module 1125, a MST module 1126 and a radio frequency (RF) module 1127.

The cellular module 1121 may provide, for example, voice communication, video communication, a character service, an Internet service, or the like over a communication network. According to an embodiment, the cellular module 1121 may perform discrimination and authentication of the electronic device 1101 within a communication network by using the subscriber identification module (e.g., a SIM card) 1129. According to an embodiment, the cellular module 1121 may perform at least a portion of functions that the processor 1110 provides. According to an embodiment, the cellular module 1121 may include a communication processor (CP).

Each of the Wi-Fi module 1122, the BT module 1123, the GNSS module 1124, the NFC module 1125, or the MST module 1126 may include a processor for processing data exchanged through a corresponding module, for example. According to an embodiment, at least a part (e.g., two or more) of the cellular module 1121, the Wi-Fi module 1122, the BT module 1123, the GNSS module 1124, the NFC module 1125, or the MST module 1126 may be included within one Integrated Circuit (IC) or an IC package.

For example, the RF module 1127 may transmit and receive a communication signal (e.g., an RF signal). For example, the RF module 1127 may include a transceiver, a power amplifier module (PAM), a frequency filter, a low noise amplifier (LNA), an antenna, or the like. According to another embodiment, at least one of the cellular module 1121, the Wi-Fi module 1122, the BT module 1123, the GNSS module 1124, the NFC module 1125, or the MST module 1126 may transmit and receive an RF signal through a separate RF module.

The subscriber identification module 1129 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 1130 (e.g., the memory 1030) may include an internal memory 1132 or an external memory 1134. For example, the internal memory 1132 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 1134 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 1134 may be operatively and/or physically connected to the electronic device 1101 through various interfaces.

A security module 1136 may be a module that includes a storage space of which a security level is higher than that of the memory 1130 and may be a circuit that guarantees safe data storage and a protected execution environment. The security module 1136 may be implemented with a separate circuit and may include a separate processor. For example, the security module 1136 may be in a smart chip or a secure digital (SD) card, which is removable, or may include an embedded secure element (eSE) embedded in a fixed chip of the electronic device 1101. Furthermore, the security module 1136 may operate based on an operating system (OS) that is different from the OS of the electronic device 1101. For example, the security module 1136 may operate based on java card open platform (JCOP) OS.

The sensor module 1140 may measure, for example, a physical quantity or may detect an operation state of the electronic device 1101. The sensor module 1140 may convert the measured or detected information to an electric signal. For example, the sensor module 1140 may include at least one of a gesture sensor 1140A, a gyro sensor 1140B, a barometric pressure sensor 1140C, a magnetic sensor 1140D, an acceleration sensor 1140E, a grip sensor 1140F, the proximity sensor 1140G, a color sensor 1140H (e.g., red, green, blue (RGB) sensor), a biometric sensor 1140I, a temperature/humidity sensor 1140J, an illuminance sensor 1140K, or an UV sensor 1140M. Although not illustrated, additionally or alternatively, the sensor module 1140 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1140 may further include a control circuit for controlling at least one or more sensors included therein. According to an embodiment, the electronic device 1101 may further include a processor that is a part of the processor 1110 or independent of the processor 1110 and is configured to control the sensor module 1140. The processor may control the sensor module 1140 while the processor 1110 remains at a sleep state.

The input device 1150 may include, for example, a touch panel 1152, a (digital) pen sensor 1154, a key 1156, or an ultrasonic input unit 1158. For example, the touch panel 1152 may use at least one of capacitive, resistive, infrared and ultrasonic detecting methods. Also, the touch panel 1152 may further include a control circuit. The touch panel 1152 may further include a tactile layer to provide a tactile reaction to a user.

The (digital) pen sensor 1154 may be, for example, a part of a touch panel or may include an additional sheet for recognition. The key 1156 may include, for example, a physical button, an optical key, a keypad, or the like. The ultrasonic input device 1158 may detect (or sense) an ultrasonic signal, which is generated from an input device, through a microphone (e.g., a microphone 1188) and may check data corresponding to the detected ultrasonic signal.

The display 1160 (e.g., the display 1060) may include a panel 1162, a hologram device 1164, or a projector 1166. The panel 1162 may be the same as or similar to the display 1060 illustrated in FIG. 10. The panel 1162 may be implemented, for example, to be flexible, transparent or wearable. The panel 1162 and the touch panel 1152 may be integrated into a single module. The hologram device 1164 may display a stereoscopic image in a space using a light interference phenomenon. The projector 1166 may project light onto a screen so as to display an image. For example, the screen may be arranged in the inside or the outside of the electronic device 1101. According to an embodiment, the display 1160 may further include a control circuit for controlling the panel 1162, the hologram device 1164, or the projector 1166.

The interface 1170 may include, for example, a high-definition multimedia interface (HDMI) 1172, a universal serial bus (USB) 1174, an optical interface 1176, or a D-subminiature (D-sub) 1178. The interface 1170 may be included, for example, in the communication interface 1070 illustrated in FIG. 10. Additionally or alternatively, the interface 1170 may include, for example, a mobile high definition link (MHL) interface, a SD card/multimedia card (MMC) interface, or an infrared data association (IrDA) standard interface.

The audio module 1180 may convert a sound and an electric signal in dual directions. At least a component of the audio module 1180 may be included, for example, in the input/output interface 1050 illustrated in FIG. 10. The audio module 1180 may process, for example, sound information that is input or output through a speaker 1182, a receiver 1184, an earphone 1186, or the microphone 1188.

For example, the camera module 1191 may shoot a still image or a video. According to an embodiment, the camera module 1191 may include at least one or more image sensors (e.g., a front sensor or a rear sensor), an IR camera, a lens, an image signal processor (ISP), or a flash (e.g., an LED or a xenon lamp).

The power management module 1195 may manage, for example, power of the electronic device 1101. According to an embodiment, a power management integrated circuit (PMIC), a charger IC, or a battery or fuel gauge may be included in the power management module 1195. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 1196 and a voltage, current or temperature thereof while the battery is charged. The battery 1196 may include, for example, a rechargeable battery and/or a solar battery.

The indicator 1197 may display a specific state of the electronic device 1101 or a part thereof (e.g., the processor 1110), such as a booting state, a message state, a charging state, and the like. The motor 1198 may convert an electrical signal into a mechanical vibration and may generate the following effects: vibration, haptic, and the like. Although not illustrated, a processing device (e.g., a GPU) for supporting a mobile TV may be included in the electronic device 1101. The processing device for supporting the mobile TV may process media data according to the standards of digital multimedia broadcasting (DMB), digital video broadcasting (DVB), MediaFlo™, or the like.

Each of the above-mentioned components of the electronic device according to various embodiments of the disclosure may be configured with one or more parts, and the names of the components may be changed according to the type of the electronic device. In various embodiments, the electronic device may include at least one of the above-mentioned components, and some components may be omitted or other additional components may be added. Furthermore, some of the components of the electronic device according to various embodiments may be combined with each other so as to form one entity, so that the functions of the components may be performed in the same manner as before the combination.

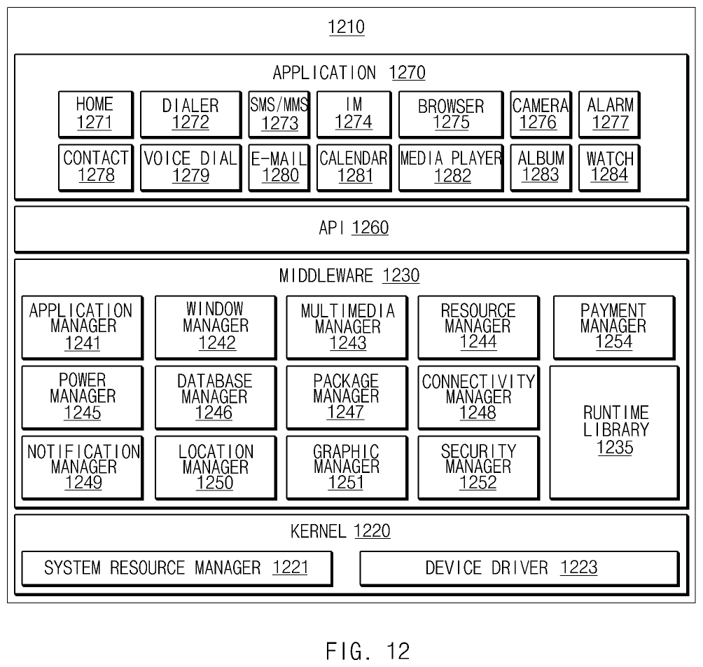

FIG. 12 illustrates a block diagram of a program module, according to various embodiments.

According to an embodiment, a program module 1210 (e.g., the program 1040) may include an operating system (OS) to control resources associated with an electronic device (e.g., the electronic device 1001), and/or diverse applications (e.g., the application program 1047) driven on the OS. The OS may be, for example, Android™, iOS™, Windows™, Symbian™, or Tizen™.

The program module 1210 may include a kernel 1220, a middleware 1230, an application programming interface (API) 1260, and/or an application 1270. At least a portion of the program module 1210 may be preloaded on an electronic device or may be downloadable from an external electronic device (e.g., the first electronic device 1002, the second electronic device 1004, the server 1006, or the like).

The kernel 1220 (e.g., the kernel 1041) may include, for example, a system resource manager 1221 or a device driver 1223. The system resource manager 1221 may perform control, allocation, or retrieval of system resources. According to an embodiment, the system resource manager 1221 may include a process managing unit, a memory managing unit, or a file system managing unit. The device driver 1223 may include, for example, a display driver, a camera driver, a Bluetooth driver, a shared memory driver, a USB driver, a keypad driver, a Wi-Fi driver, an audio driver, or an inter-process communication (IPC) driver.

The middleware 1230 may provide, for example, a function that the application 1270 needs in common, or may provide diverse functions to the application 1270 through the API 1260 to allow the application 1270 to efficiently use limited system resources of the electronic device. According to an embodiment, the middleware 1230 (e.g., the middleware 1043) may include at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, a security manager 1252, or a payment manager 1254.

The runtime library 1235 may include, for example, a library module that is used by a compiler to add a new function through a programming language while the application 1270 is being executed. The runtime library 1235 may perform input/output management, memory management, or capacities about arithmetic functions.

The application manager 1241 may manage, for example, a life cycle of at least one application of the application 1270. The window manager 1242 may manage a graphic user interface (GUI) resource that is used in a screen. The multimedia manager 1243 may identify a format necessary for playing diverse media files, and may perform encoding or decoding of media files by using a codec suitable for the format. The resource manager 1244 may manage resources such as a storage space, memory, or source code of at least one application of the application 1270.

The power manager 1245 may operate, for example, with a basic input/output system (BIOS) to manage a battery or power, and may provide power information for an operation of an electronic device. The database manager 1246 may generate, search for, or modify database that is to be used in at least one application of the application 1270. The package manager 1247 may install or update an application that is distributed in the form of package file.

The connectivity manager 1248 may manage, for example, wireless connection such as Wi-Fi or Bluetooth. The notification manager 1249 may display or notify an event such as arrival message, appointment, or proximity notification in a mode that does not disturb a user. The location manager 1250 may manage location information about an electronic device. The graphic manager 1251 may manage a graphic effect that is provided to a user, or manage a user interface relevant thereto. The security manager 1252 may provide a general security function necessary for system security, user authentication, or the like. According to an embodiment, in the case where an electronic device (e.g., the electronic device 1001) includes a telephony function, the middleware 1230 may further include a telephony manager for managing a voice or video call function of the electronic device.

The middleware 1230 may include a middleware module that combines diverse functions of the above-described components. The middleware 1230 may provide a module specialized to each OS kind to provide differentiated functions. Additionally, the middleware 1230 may dynamically remove a part of the preexisting components or may add new components thereto.

The API 1260 (e.g., the API 1045) may be, for example, a set of programming functions and may be provided with a configuration that is variable depending on an OS. For example, in the case where an OS is Android™ or iOS™, it may provide one API set per platform. In the case where an OS is Tizen™, it may provide two or more API sets per platform.

The application 1270 (e.g., the application program 1047) may include, for example, one or more applications capable of providing functions for a home 1271, a dialer 1272, an SMS/MMS 1273, an instant message (IM) 1274, a browser 1275, a camera 1276, an alarm 1277, a contact 1278, a voice dial 1279, an e-mail 1280, a calendar 1281, a media player 1282, an album 1283, or a watch 1284, or for offering health care (e.g., measuring an exercise quantity, blood sugar, or the like) or environment information (e.g., information of barometric pressure, humidity, temperature, or the like).

According to an embodiment, the application 1270 may include an application (hereinafter referred to as “information exchanging application” for descriptive convenience) to support information exchange between an electronic device (e.g., the electronic device 1001) and an external electronic device (e.g., the first electronic device 1002 or the second electronic device 1004). The information exchanging application may include, for example, a notification relay application for transmitting specific information to an external electronic device, or a device management application for managing the external electronic device.

For example, the notification relay application may include a function of transmitting notification information, which arise from other applications (e.g., applications for SMS/MMS, e-mail, health care, or environmental information), to an external electronic device. Additionally, the notification relay application may receive, for example, notification information from an external electronic device and provide the notification information to a user.

The device management application may manage (e.g., install, delete, or update), for example, at least one function (e.g., turn-on/turn-off of an external electronic device itself (or a part) or adjustment of brightness (or resolution) of a display) of the external electronic device which communicates with the electronic device, an application running in the external electronic device, or a service (e.g., a call service, a message service, or the like) provided from the external electronic device.

According to an embodiment, the application 1270 may include an application (e.g., a health care application of a mobile medical device) that is assigned in accordance with an attribute of an external electronic device. According to an embodiment, the application 1270 may include an application that is received from an external electronic device (e.g., the first electronic device 1002, the second electronic device 1004, or the server 1006). According to an embodiment, the application 1270 may include a preloaded application or a third party application that is downloadable from a server. The names of components of the program module 1210 according to the embodiment may be modifiable depending on kinds of operating systems.

According to various embodiments, at least a portion of the program module 1210 may be implemented by software, firmware, hardware, or a combination of two or more thereof. At least a portion of the program module 1210 may be implemented (e.g., executed), for example, by the processor (e.g., the processor 1110). At least a portion of the program module 1210 may include, for example, modules, programs, routines, sets of instructions, processes, or the like for performing one or more functions.

The term “module” used in the disclosure may represent, for example, a unit including one or more combinations of hardware, software and firmware. The term “module” may be interchangeably used with the terms “unit”, “logic”, “logical block”, “part” and “circuit”. The “module” may be a minimum unit of an integrated part or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 1020), may cause the one or more processors to perform a function corresponding to the instruction. The computer-readable storage media, for example, may be the memory 1030.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, the one or more instructions may contain a code made by a compiler or a code executable by an interpreter. The above hardware unit may be configured to operate via one or more software modules for performing an operation according to various embodiments, and vice versa.

A module or a program module according to various embodiments may include at least one of the above components, or a part of the above components may be omitted, or additional other components may be further included. Operations performed by a module, a program module, or other components according to various embodiments may be executed sequentially, in parallel, repeatedly, or in a heuristic method. In addition, some operations may be executed in different sequences or may be omitted. Alternatively, other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic apparatus comprising:
a sensor configured to detect movement of the electronic apparatus;
a camera configured to photograph an external object to the apparatus;
a display configured to output an image corresponding to the external object to the apparatus; and
a processor configured to be electrically connected to the display,
wherein the processor is configured to:
obtain a first image of a part of the external object to the apparatus through the camera, wherein the obtaining of the first image includes identifying a first position of the electronic apparatus with respect to the external object to the apparatus using the sensor;
determine a movement path of the electronic apparatus from the first position to a second position capable of obtaining a second image to generate a stereoscopic image of the external object to the apparatus with the first image; and
output a virtual path corresponding to the movement path through the display.

2. The electronic apparatus of claim 1, wherein the processor is configured to:
determine the virtual path based on the movement path and the movement of the electronic apparatus while the electronic apparatus generates at least a part of the stereoscopic image; and
output the virtual path with respect to a guide surrounding the external object to the apparatus though the display.

3. The electronic apparatus of claim 1, wherein the processor is configured to:
output the stereoscopic image generated based on the first image and the second image through the display.

4. The electronic apparatus of claim 2, wherein the processor is configured to:
determine a ground plane supporting the external object to the apparatus; and
be disposed on a plane parallel to the ground plane for the guide.

5. The electronic apparatus of claim 1, wherein the processor is configured to:
detect a slope of the electronic apparatus using the sensor; and
determine the virtual path based on the slope.

6. The electronic apparatus of claim 1, wherein the processor is configured to:
output the movement path through the display.

7. The electronic apparatus of claim 2, wherein the processor is configured to:
set a threshold region based on a position of the guide; and
output the threshold region through the display.

8. The electronic apparatus of claim 7, wherein the processor is configured to:
photograph the external object to the apparatus through a first pipeline based on the virtual path, which is disposed within the threshold region; and
photograph the external object to the apparatus through the first pipeline and a second pipeline based on the virtual path, which is disposed outside the threshold region.

9. The electronic apparatus of claim 2, wherein the processor is configured to:
output a first guide parallel to the guide and spaced apart from the guide by a specific distance and a second guide disposed at an opposite side of the first guide with respect to the guide through the display.

10. The electronic apparatus of claim 2, wherein the processor is configured to:
output a vertical guide, which is perpendicular to the guide, is disposed on a plane including a position which starts the photographing, and surrounds the external object to the apparatus, through the display; and
obtain the first position based on the guide and the vertical guide.

11. The electronic apparatus of claim 1, wherein the processor is configured to:
obtain a first axis perpendicular to a ground plane supporting the external object to the apparatus, a second axis which is perpendicular to the first axis and is disposed on a plane including a position where the photographing starts, and a reference line connecting an intersection of the first axis and the second axis to the electronic apparatus; and
obtain the first position based on the second axis and an angle of the reference line.

12. The electronic apparatus of claim 11, wherein the processor is configured to:
obtain a third axis perpendicular to the first axis and the second axis, and
obtain the first position based on coordinate values of the electronic apparatus and coordinate values of the external object to the apparatus in a coordinate system including the first axis, the second axis, and the third axis.

13. The electronic apparatus of claim 1, wherein the processor is configured to:
start the electronic apparatus at a first point of the movement path and to finish the photographing when the electronic apparatus arrives at a second point of the movement path, and
wherein the first point corresponds to the second point.

14. The electronic apparatus of claim 1, wherein the processor is configured to:
output an icon having a slope corresponding to a slope of the electronic apparatus through the display.

15. A method of photographing an external object to an electronic apparatus comprising:
identifying a first position of the electronic apparatus through a sensor;
obtaining a first image with respect to a part of the external object to the apparatus through a camera;
determining a movement path of the electronic apparatus from the first position to a second position capable of obtaining a second image to generate a stereoscopic image of the external object to the apparatus with the first image; and
outputting a virtual path corresponding to the movement path through a display.
